(19) United States
(12) Patent Application Publication
(10) Pub. No.: US 2015/0368083 A1
(43) Pub. Date: Dec. 24, 2015

(54) BOTTLE SABERING

(71) Applicant: Coup Brands IP, LLC, Benicia, CA (US)

(72) Inventors: Ryan Tu, Benicia, CA (US); Tark Abed, Palo Alto, CA (US); Feng Hao Yu, Sunnyvale, CA (US); Peter Privitera, San Francisco, CA (US); Lawson Fisher, Portola Valley, CA (US); Natasha Gangjee, Mountain View, CA (US); Ryan Braunstein, San Carlos, CA (US)

(21) Appl. No.: 14/313,779

(22) Filed: Jun. 24, 2014

(51) Int. Cl. B67B 7/92

(52) U.S. Cl. CPC B67B 7/92

(57) ABSTRACT

A rack for bottle sabering includes an elongated body defining an open compartment dimensioned to accommodate a pressurized bottle of fluid. The body partially encloses the bottle, leaving at least an underside of a neck and rim on one side of the bottle exposed for a sabering strike to sever the top of the bottle.

### TECHNICAL FIELD

This specification generally relates to bottle sabering, and more particularly to racks and methods for severing the top of a pressurized bottle according to various bottle-sabering techniques.

### BACKGROUND

Bottle sabering, also known as “sabrage,” is a ceremonial technique for opening a pressurized glass bottle, such as a sparkling wine or champagne bottle, by severing its top with a solid object—typically a saber. Conventionally, sabrage involves sliding the saber rapidly along a seam of the bottle until it strikes a raised lip at the bottle's rim. The intersection of the seam and the lip creates a stress concentration that significantly decreases the strength of the glass bottle. The impact of the saber's edge at the bottle's weak point creates a rapidly expanding crack that severs the top from the bottle. With the bottle top removed, the contents of the bottle can be freely poured.

Sabrage is increasingly a unique addition to many gatherings and celebrations. When performed correctly, the technique is dramatic and impressive to spectators. However, when not performed precisely, there is a serious risk of shattering the bottle entirely. Thus, apparatus and methods are sought to perform sabrage safely and reliably.

### SUMMARY

One aspect of the invention features a rack for bottle sabering including: an elongated body defining an open compartment dimensioned to accommodate a pressurized bottle of fluid; and a cover member coupled to the body and positioned so as to extend beyond a top of the bottle when the bottle is supported by the body. The body and the cover member cooperate to partially enclose the bottle, leaving at least an underside of a neck and rim on one side of the bottle exposed for a sabering strike to sever the top of the bottle. The cover member defines a receptacle for catching the severed top of the bottle.

In some examples, the bottle is fixedly coupled to the body. In some applications, the bottle is positioned within the body such that a seam of the bottle is exposed for contact by a saber. By “saber” we refer to any structure suitable for executing a sabrage technique disclosed herein. In some examples, where the saber itself contacts the bottle's weak point, the requisite structure of the saber may include a relatively sturdy edge. Thus, in some examples, the saber is formed from a material including hardened steel. However, in certain other examples where the saber is merely used to contact a trigger that actuates a spring-loaded severing device, the permissible structure of the saber may be significantly more forgiving. That is, in such examples, the saber can be any structure of sufficient rigidity to contact the trigger with sufficient force to actuate the severing device.

In some embodiments, the bottle is wrapped in a flexible sleeve. In some cases, an interior surface of the body is lined with a grip material. In some implementations, the open compartment of the rack is bounded by an edge surface bordering the neck and rim of the bottle, the edge surface providing a guide surface for facilitating the sabering strike. In some examples, the cover member is fashioned from a high-impact material.

In some implementations, the receptacle comprises an energy absorbing material. In some embodiments, the energy absorbing material comprises foam. In some applications, the receptacle comprises a one-way door to inhibit unintentional release of the severed top of the bottle. In some cases, the receptacle comprises a bag mounted to receive the severed top of the bottle as the severed bottle top enters the receptacle, the bag being removable from the receptacle.

In some examples, the rack further includes a severing device coupled to the body, the severing device comprising a striker configured to strike the rim of the bottle in response to an impact on the severing device by the saber. In some applications, the striker is biased by a spring member that releases stored energy into the striker in response to the impact on the severing device by the saber. In some implementations, the spring member comprises a torsional spring. In some cases, the striker is oriented to traverse an arc strike path in response to the impact on the severing device by the saber. In some embodiments, the striker is oriented to traverse a linear strike path in response to the impact on the severing device by the saber. In some applications, the striker is fashioned from a hardened-steel material. In some cases, the pressurized bottle is positioned within the body such that a seam of the bottle is aligned with the striker. In some implementations, the severing device further comprises a trigger positioned to receive the impact by the saber and actuate the striker in response to the impact.

In some examples, the rack further includes at least one light source coupled to the body. In some applications, the body is fashioned from a transparent material. In some embodiments, the light source comprises a light-emitting diode (LED). In some implementations, the rack further includes a controller electronically coupled to the light source, and configured to operate the light source in response to feedback from a sensor. In some examples, the sensor comprises a tilt sensor responsive to changes in the orientation of the body. In some cases, the sensor is responsive to changes in a severing device coupled to the body. In some embodiments, the controller is configured to alter operation of the light source in response to determining that the body has achieved an angle of tilt suitable for sabering. In some applications, the controller is configured to alter operation of the light source in response to determining that the body has achieved an angle of tilt suitable for sabering. In some cases, the controller is configured to alter operation of the light source in response to determining that the top of the bottle has been severed.

Another aspect of the invention features a method of opening a pressurized bottle of fluid, including: supporting the bottle in a rack that partially encloses the bottle, leaving at least an underside of a neck and rim on one side of the bottle exposed; sliding a saber up the neck of the bottle with force to cause an impact at the underside of the rim sufficient to sever a top of the bottle; and catching the severed top of the bottle in a receptacle of the rack, the receptacle defined by a portion of the rack that extends beyond the top of the bottle when the bottle is supported in the rack.

In some examples, supporting the bottle in the rack comprises fixedly securing the bottle in the rack. In some applications, supporting the bottle in the rack includes: wrapping the bottle in a flexible sleeve; and inserting the sleeved bottle into a compartment defined by the rack. In some cases, supporting the bottle in the rack comprises positioning the bottle within a compartment defined by the rack such that a seam of the bottle is exposed.

In some implementations, sliding a saber up the neck of the bottle comprises pressing the saber against a guide surface of the rack as the saber moves along the neck of the bottle. In some examples, sliding a saber up the neck of the bottle with force to cause an impact at the underside of the rim comprises contacting an edge of the saber with the underside of the rim. In some embodiments, sliding a saber up the neck of the bottle with force to cause an impact at the underside of the rim comprises contacting an edge of the saber with a severing device attached to the rack. In some applications, the severing device comprises a striker configured to strike the rim of the bottle in response to contact by the edge of the saber.

One aspect of the invention features a rack for bottle sabering including an elongated bottle support including a yoke and a collar. The yoke and the collar are arranged to cooperate to partially enclose a pressurized bottle of fluid supported by the bottle support, leaving at least an underside of a neck and rim on one side of the bottle exposed for a sabering strike to sever the top of the bottle. The collar is bounded by an edge surface positioned to extend along the neck of the bottle with the bottle enclosed by the yoke and collar, the edge surface aligned with the bottle neck to provide a continuous point of contact for a saber slid along the bottle neck toward the bottle rim.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is perspective view of a first example rack for bottle sabering.

FIGS. 2A-2D are progressive views illustrating a bottle-sabering method using a second example rack.

FIG. 3 is a perspective view of a third rack for bottle sabering.

FIGS. 4A and 4B are progressive views illustrating a bottle-sabering method using a fourth example rack.

FIG. 5 is a perspective view of a fifth rack for bottle sabering.

FIG. 6 is a perspective view of a sixth rack for bottle sabering.

FIGS. 7A and 7B are perspective views of adjustable strikers for use in a severing device of a bottle-sabering rack.

FIG. 8 is a perspective view of seventh rack for bottle sabering.

FIG. 9 is a perspective view of an eighth rack for bottle sabering.

FIGS. 10A and 10B are side views illustrating a bottle-sabering method using a ninth example rack.

FIGS. 11A and 11B are front and rear views of a tenth rack for bottle sabering.

FIG. 11C is a diagram illustrating a control architecture for operating light sources incorporated in a bottle-sabering rack.

FIG. 12 is a perspective view of an eleventh rack for bottle sabering.

FIGS. 13A and 13B are side and perspective views of a device for holstering a saber to a bottle rack.

Various features may be exaggerated to better show the features, process steps, and results. Like reference numbers and designations in the various drawings indicate like elements.

### DETAILED DESCRIPTION

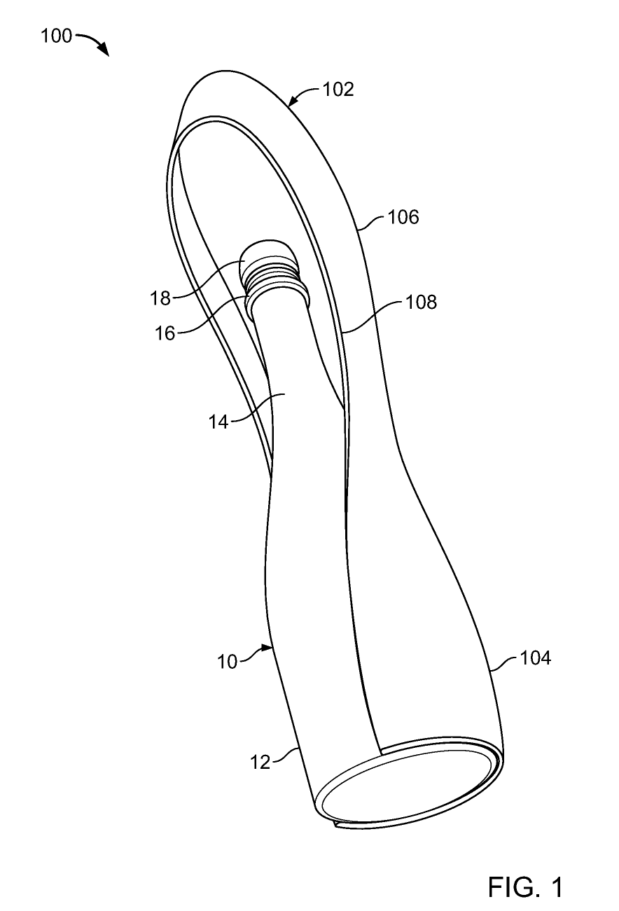

FIG. 1 illustrates an example rack 100 that may be used to perform a bottle-sabering technique. As shown, rack 100 includes a body 102 defining an open compartment dimensioned to accommodate a pressurized bottle 10. Bottle 10 can contain any consumable fluid safely held under pressure. In many implementations, the fluid is a pressurized distilled beverage (e.g., champagne). Body 102 is a monolithic structure featuring a yoke 104 and a collar 106 that cooperate to partially enclose bottle 10. In this example, an entire frontal arc section, extending from top to bottom, of the pressurized bottle remains exposed (i.e., uncovered by the rack). However, it is appreciated that more or less of the bottle may be covered by the rack so long as the bottle's weak point is exposed for contact by the saber. Thus, in various examples, at least an underside of a neck and rim along an arc section of the bottle are left exposed. Further, the bottle may be positioned in the rack such that a seam of the bottle is left exposed.

Bottle 10 is held in a fixed position relative to rack 100. As shown, an inner surface of the rack's yoke 104 is contoured to receive a base 12 of bottle 10. Bottle 10 may be permanently or releasably coupled to the rack's yoke 104. For instance, the bottle's base could be permanently attached to the yoke of the rack by adhesive, or merely held in place by friction between surfaces of the bottle and the body. In some examples, an inner surface of the yoke is lined with a grip material (e.g., a non-slip or slip-resistant fabric, foam or plastic material) that increases the surface friction. Further, in some examples, the yoke is formed from a compliant material so that it can accommodate bottles of various sizes.

The rack's collar 106 extends integrally from its yoke 104 and provides an edge 108 bordering a neck 14 and rim 16 of bottle 10. In this example, edge 108 is contoured to provide a guide for facilitating a sabering strike to sever the top 18 of bottle 10. More specifically, the bordering edge of the collar provides a continuous point of contact for the saber on either side of the bottle's neck and rim to facilitate a clean sabering strike by the user. Thus, to safely execute a sabering strike, a user can slide the saber along edge 108. The contoured edge creates a track to guide the path of the saber through the “weak point” at the neck-rim-seam intersection of the bottle and provides a stabilizing effect as the user thrusts the saber along the bottle's seam. Further, the hollow, arcuate shape of the collar creates a carrying handle that allows a user to carry one or more bottle racks at a time by gripping the collar.

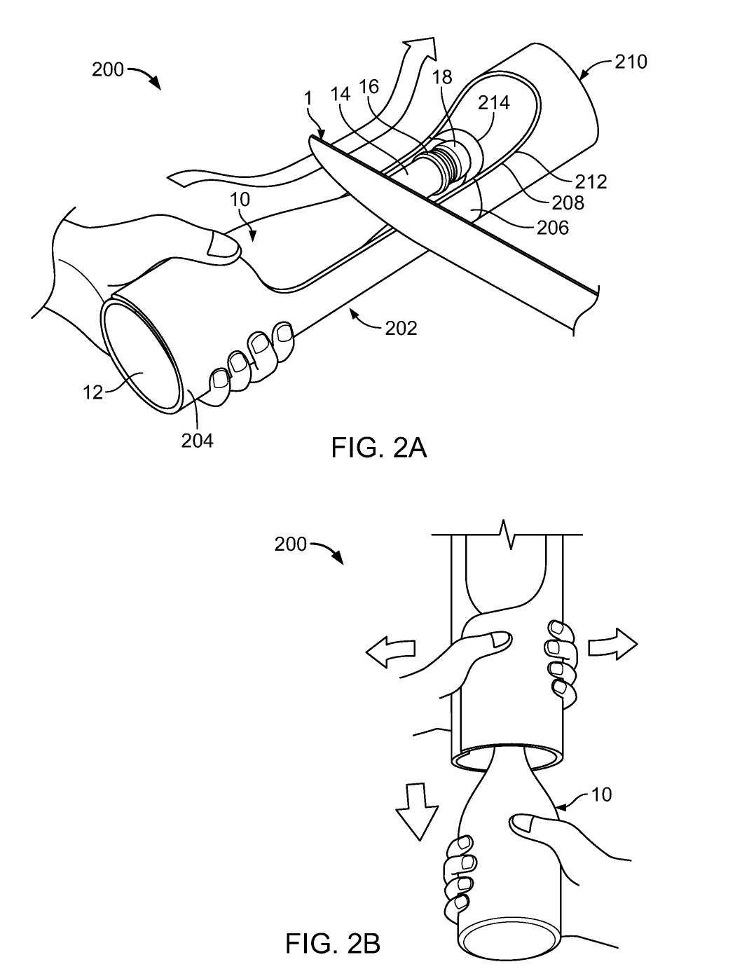

FIGS. 2A-2D are illustrative of a bottle-sabering method. Referring first to FIG. 2A, the pressurized bottle of fluid 10 is supported in a rack 200 that partially encloses the bottle. In this example, the yoke 204 of rack 200 wraps entirely around the bottle's base 12. Yet, the neck 14 and rim 16 of bottle 10 remain exposed for contact by saber 1. The saber illustrated in FIG. 2A is a conventional one-edged sword, with the blunt backside of the striker being used to contact the bottle's weak point. In some examples, the saber is formed from a plastic material. Such a plastic saber may be designed to facilitate sabarage techniques where the saber itself contacts the bottle and/or techniques where the saber contacts the severing device or a trigger for the severing device.

Rack 200 includes a cover member 210 detachably coupled to body 202. As shown, with the bottle positioned in the rack, the cover member is positioned so as to extend beyond the top of the bottle. Cover member 210 provides a contoured edge 212 that cooperates with edge 208 of collar 206 to create a track for the sabering strike. Cover member 210 defines a receptacle 214 for catching the severed top 18 of bottle 10. In some examples, a material composition of at least an inner surface of the receptacle includes a high-impact material of sufficient strength to resist cracking, shattering, or other modes of failure, in response to forcible contact with the severed top of the bottle. In some examples, a material composition of at least an inner surface of the receptacle includes an energy-absorbing material (e.g., rubber or foam) designed to absorb and dissipate the energy of the severed bottle top.

Once its top 18 has been severed, bottle 10 is removed from rack 200, as shown in FIG. 2B. FIG. 2C illustrates how the fluid contents of bottle 10 can flow freely from an opening at bottle neck 14. Finally, at FIG. 2D, the severed bottle top 18 captured by the receptacle 214 is discarded from the detached cover member 210.

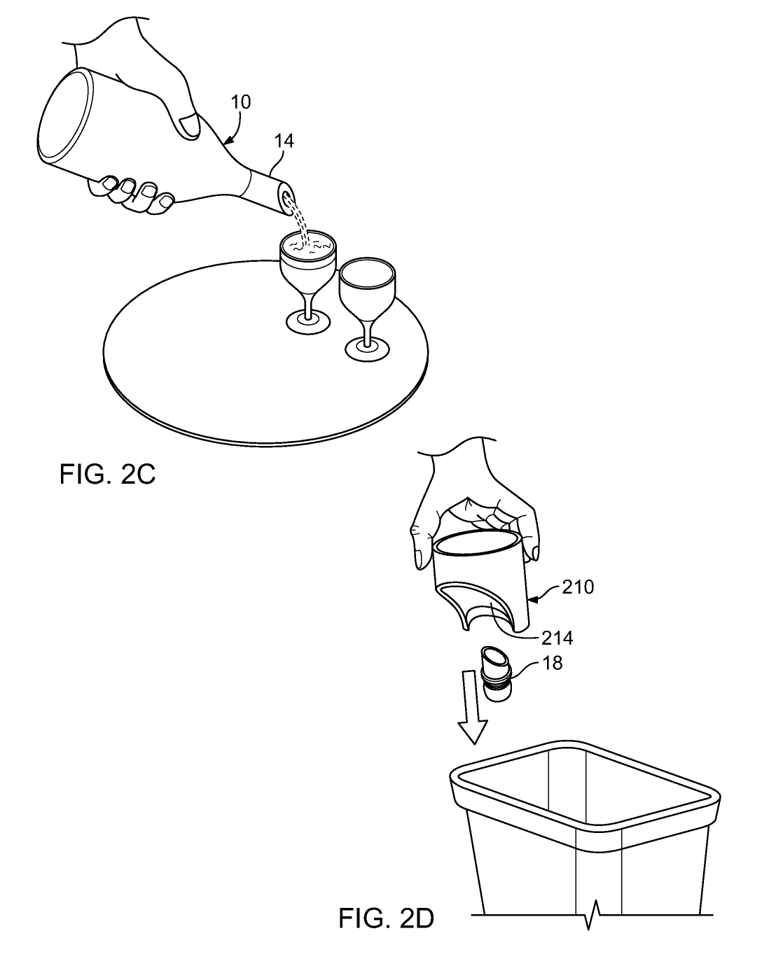

FIG. 3 illustrates another example rack 300 that may be used to perform a bottle-sabering technique. Rack 300 is similar to rack 100, featuring a body 302 including a yoke 304 and a collar 306 that cooperate to partially enclose bottle 10. However, in this example, rack 300 further includes a severing device 315 including a striker 316 for creating an impact at the weak point of bottle 10. The severing device is designed to assist the user with executing a clean sabering strike.

As shown, striker 316 is U-shaped member featuring two parallel prongs 318 extending outward from a support bar 320. Support bar 320 is rotatably coupled to a spine member 321 of body 302. Prongs 318 are fixed with respect to support bar 320. Thus, rotation of the support bar causes the prongs to pivot relative to the body of the rack, tracing an arc strike path. Prongs 318 are positioned on either side of the bottle's neck 14, just below its weak point. When a user contacts the underside of prongs 318 with a saber, the rotating action of support bar 320 causes an inside edge of the prongs to impact bottle 10 at its weak point (thus, the bottle may be positioned in the rack such that the seam is aligned with the inside edge of the striker's prongs). The inside edge of the prongs may be designed as an ideal sabering edge. For example, the inside edge of the prongs may be relatively smooth and fashioned from a hardened-steel material.

In this example, the striker is arranged such that force imparted on the prongs is directly transferred to the bottle's weak spot. Thus, the user must deliver sufficient force to the striker with the saber to sever the bottle's top from its neck. The severing device aims the user's force at the bottle's weak point.

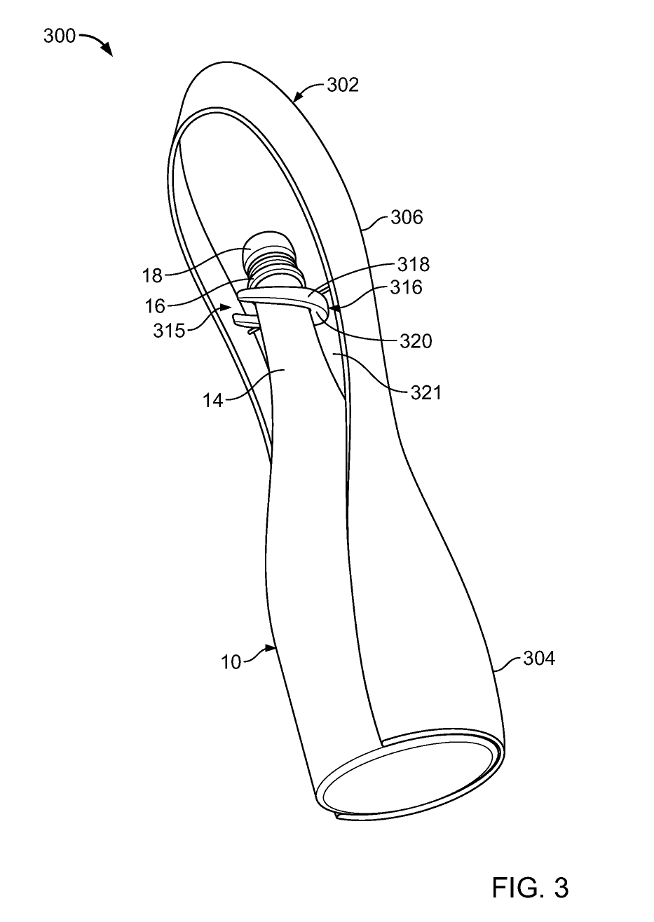

FIGS. 4A and 4B are illustrative of another bottle-sabering method. Referring first to FIG. 4A, the pressurized bottle of fluid 10 is fixedly held in a rack 400 that partial encloses the bottle. Rack 400 includes a body 402, a cover member 410, and a severing device 415. Body 402 features a yoke 404 and a collar 406. Cover member 410 features a one-way door 422 leading to the interior of receptacle 414. Severing device 415 includes a pivoting striker 416. To sever the top of bottle 10, the user slides saber 1 along the bottle neck into contact with the prongs of striker 416. As shown in FIG. 4B, contact by saber 1 causes striker 416 to pivot upward to sever the bottle top 18. Further, in this example, one-way door 422 pivots inward to allow the severed bottle top 18 to enter receptacle 414. With bottle top 18 secured within receptacle 414, one-way door 422 recovers to its original closed position to prevent an unintentional release of the severed top.

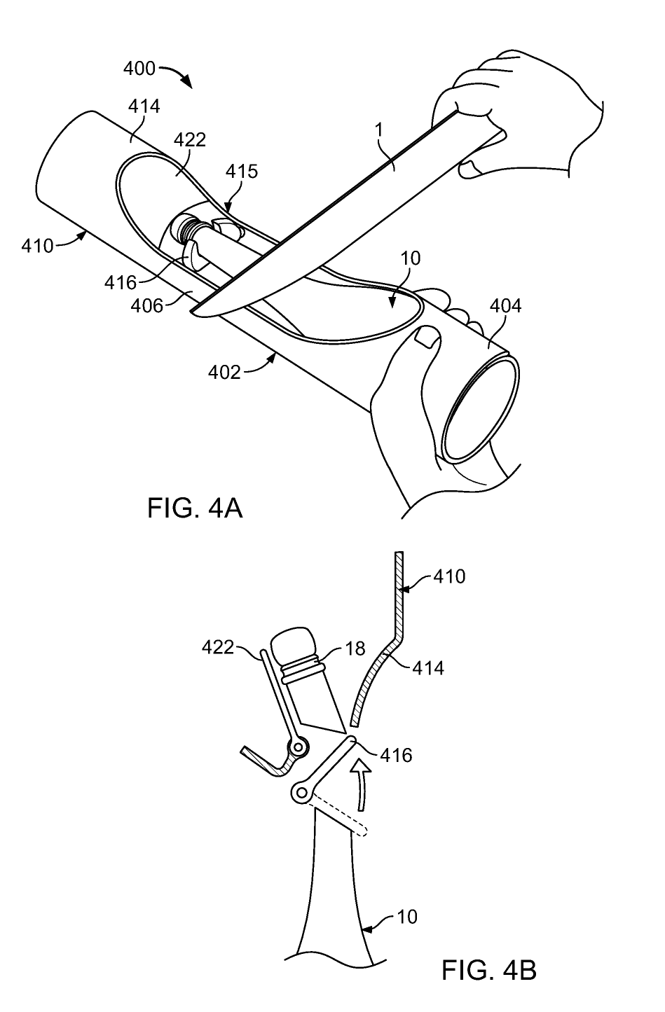

FIG. 5 illustrates an example rack 500 that may be used to perform a bottle-sabering technique. Rack 500 is similar to rack 400, featuring a body 502 and a cover member 510 featuring a one-way door 522 leading to the interior space of a receptacle. However, in this example, rack 500 includes a severing device 515 with a translating striker 516 (as compared to pivoting strikers 316 and 416). As shown, striker 516 is mounted on a pair of slots 524 formed in a spine member 521 of body 502. Thus, when the user contacts the underside of prongs 518 with a saber, the upward linear motion along slots 524 causes the inside edge of the prongs to impact bottle 10 at its weak point, severing bottle top 18 from bottle neck 14.

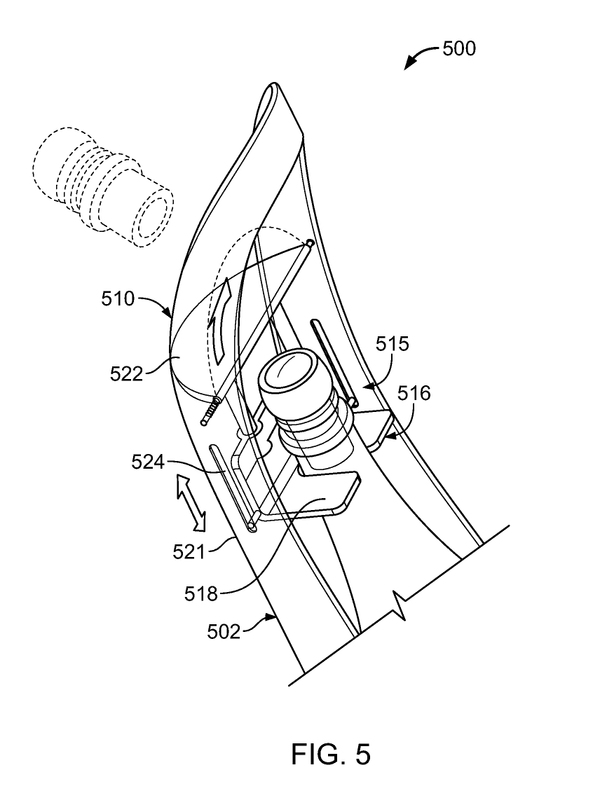

FIG. 6 illustrates an example rack 600 that may be used to perform a bottle-sabering technique. Rack 600 is similar to rack 300 featuring a body 602, including a yoke 604 and a collar 606 that cooperate to partially enclose bottle 10, and a severing device 615. In this example, the severing device is designed to provide mechanical advantage to the sabering strike, such that the user can execute sabrage with less force behind the saber than is typically required. Severing device 615 includes a pivoting striker 616 and a trigger 626 positioned beneath the striker. Striker 616 exhibits a substantially identical shape and size as striker 316. Striker 616 is loaded with a torsion spring (not shown) mounted along support bar 620 to execute an upward pivoting motion of prongs 618 with sufficient force to sever the top 18 of bottle 10.

Trigger 626 is designed to actuate striker 616, causing the spring-loaded striker to execute the upward pivoting motion. As shown, trigger 626 has a similar U-shape as striker 616, and is pivotally mounted to spine member 621 directly beneath the striker. Thus, a bottle-sabering technique is executed when the user slides a saber along the bottle's neck 14 into contact with prongs 628 of trigger 626. In response to contact by the saber, prongs 628 swing upward, pivoting about a support bar 630 of trigger 626, into contact with prongs 618 of striker 616. The forceful contact with prongs 618 releases the wound torsion spring of striker 616 and causes the striker to execute the upward pivoting motion that severs the top 18 of bottle 10. In some examples, a similar trigger can be incorporated in a severing device featuring a translating striker (e.g., severing device 515).

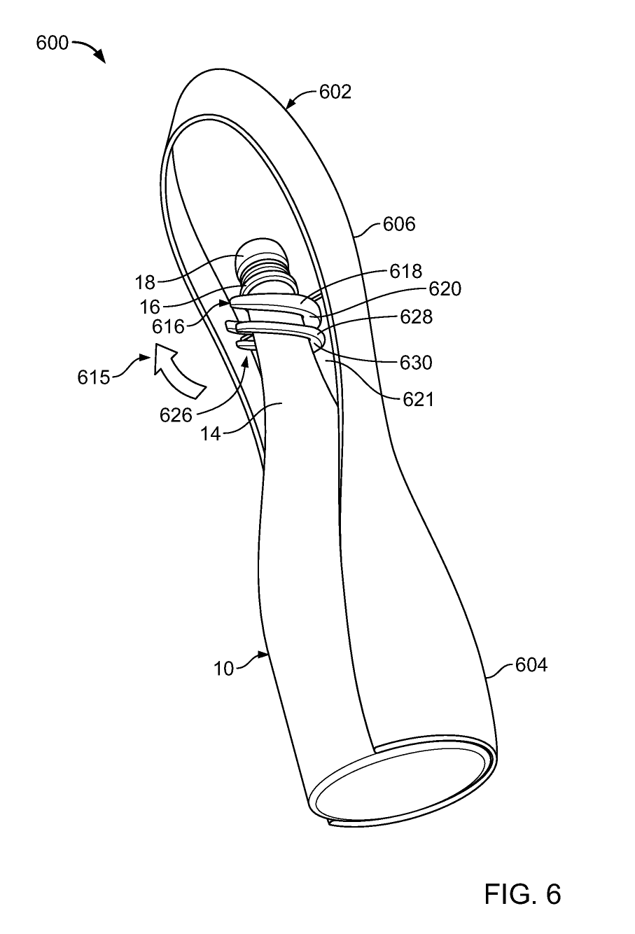

FIGS. 7A and 7B illustrate a first and second adjustable striker 716a, 716b. The adjustable strikers are designed to provide tolerance to varying bottle neck diameters. That is, the adjustable strikers can ensure that the inside edge of the prongs meant for striking the weak point is in intimate contact with the bottle. As shown, strikers 716a and 716b feature prongs 718a, 718b that are movable along the rotational axis 732 of the support bar 720a, 720b. Referring first to FIG. 7A, opposing prongs 718a of striker 716a are mounted on a common support bar 720 rotatably coupled to a spine member of the rack's body. The prongs are torsionally mounted on the support bar such that rotation of the support bar causes the prongs to translate along the rotational axis of the support bar. For example, rotation of the support bar in one direction may widen the prongs to accommodate a bottle with a wider neck, and rotation of the support bar in the opposing direction may bring the prongs closer together. Referring next to FIG. 7B, each of the opposing prongs 718b of striker 716b is integrally formed with a respective support bar 720b. The opposing prong/support bar components are coupled by a biasing spring 734 that urges them inward toward one another. To accommodate the neck of a pressurized bottle, the components are pulled away from one another against the spring force by a user and then released, allowing the spring force to urge them back inward until the prongs contact the bottle neck.

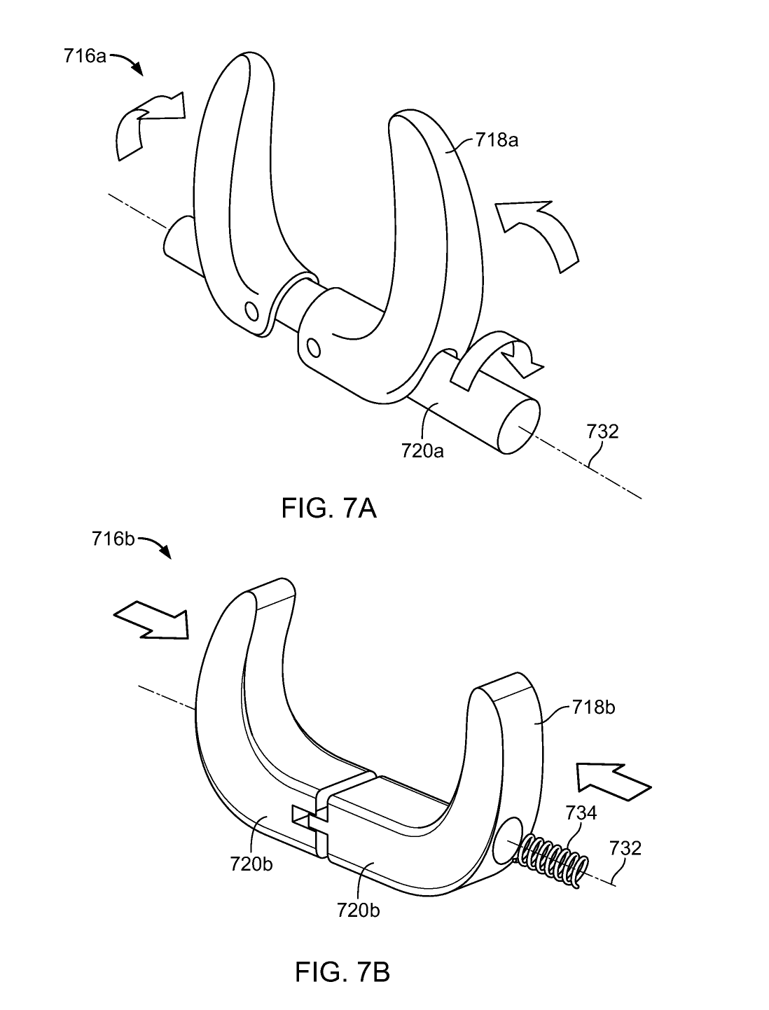

FIG. 8 illustrates yet another example rack 800 that may be used to perform a bottle-sabering technique. Rack 800 is similar to rack 600, featuring a body 802, including a yoke (not shown) and a collar 806 that cooperate to partially enclose bottle 10, and a severing device 815. Severing device 815 includes a spring-loaded striker 816 and a trigger 826 designed to actuate the striker. In this example, striker 816 includes a single prong 818 extending integrally from a support bar 820 rotatably coupled to collar 806. As shown, the single prong is positioned just below the weak point of bottle 10 at the intersection between its neck and rim. Prong 818 features a ridge 836 upstanding from its inside edge. The ridge serves to concentrate force applied to the prong by the torsional spring, which improves both reliability and repeatability of the sabering strike.

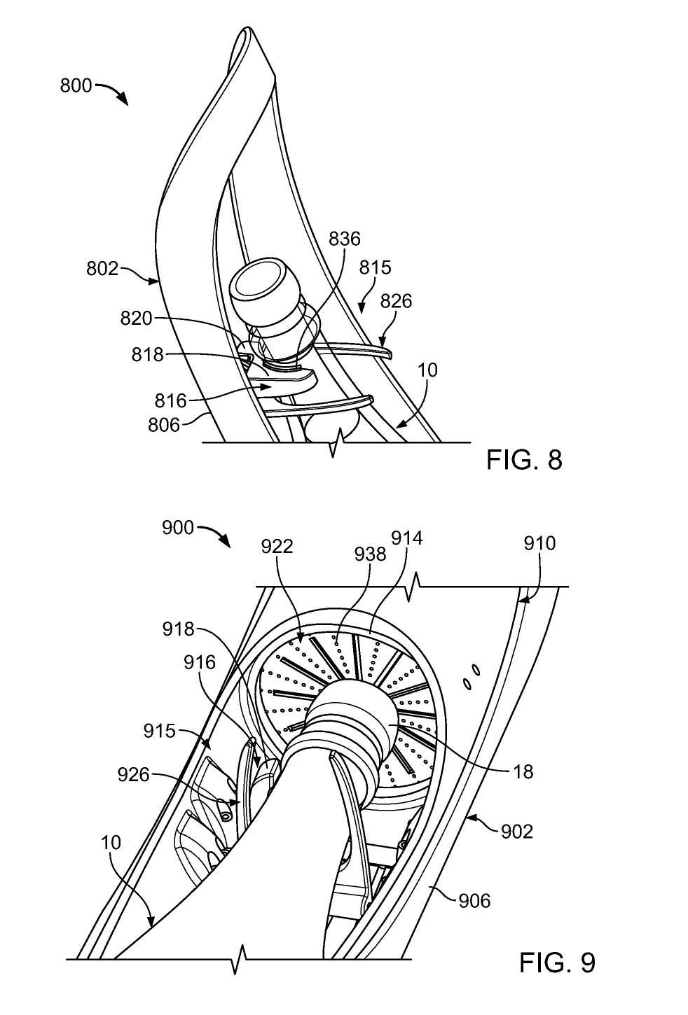

FIG. 9 illustrates yet another example rack 900 that may be used to perform a bottle-sabering technique. Rack 900 is similar to rack 800, featuring a body 902, including a yoke (not shown) and a collar 906 that cooperate to partially enclose bottle 10, and a severing device 915 including a striker 916 having a single prong 918, and a trigger 926. In this example, rack 900 further includes a cover member 910 integrally formed with collar 906 and extending above bottle 10. Cover member 910 defining a receptacle 914 for catching the severed top 18 of bottle 10. A door 922 covers the opening leading to the receptacle. Door 922 includes a plurality of flexible and resilient flaps 938. As shown, flaps 938 are triangularly shaped and arranged in a circumferential arrangement. The configuration of the flaps creates point near the center of the door that is more readily penetrated. Thus, the bottle 10 is situated in rack 900 such that the bottle top 18 is aligned with the center of door 922. The flexibility of flaps 938 permit the severed bottle top 18 to forcibly penetrate/open door 922, while their resiliency allows them to recover to their original state which closes the door and traps the severed bottle top in receptacle 914.

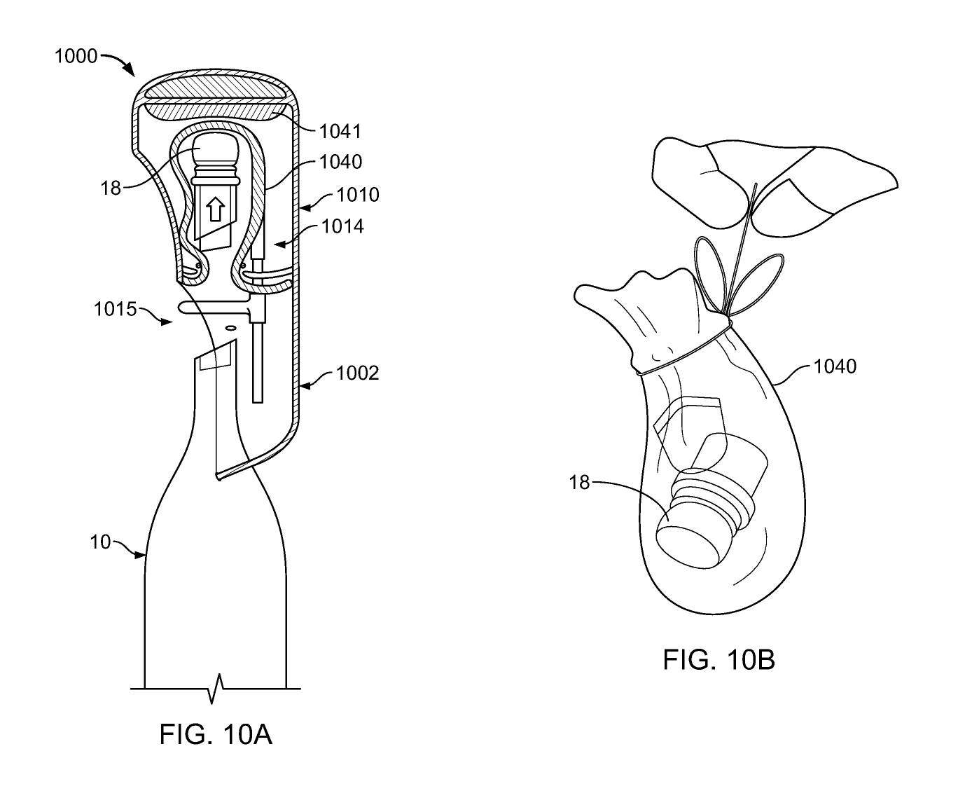

FIGS. 10A and 10B are illustrative of yet another bottle-sabering method. Referring first to FIG. 10A, the pressurized bottle of fluid 10 is fixedly held in a rack 1000 that partially encloses the bottle. Rack 1000 is similar to rack 500, featuring a body 1002 (shown partially), a cover member 1010, and a severing device 1015 including a translating striker. In this example, a flexible bag 1040 is mounted in the receptacle 1014 and arranged to receive the severed bottle top 18. A cushion 1041 composed of an-energy absorbing material is located above flexible bag 1040 within receptacle 1014. As shown in FIG. 10B, with bottle top 18 enveloped by flexible bag 1040, the bag is removed from receptacle 1014 and tied off to secure the bottle top as a memento for the user.

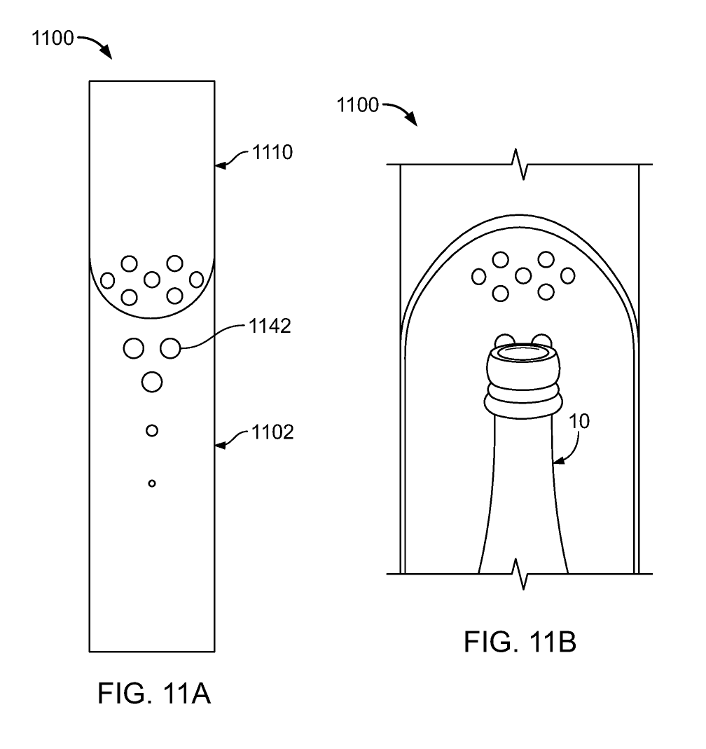

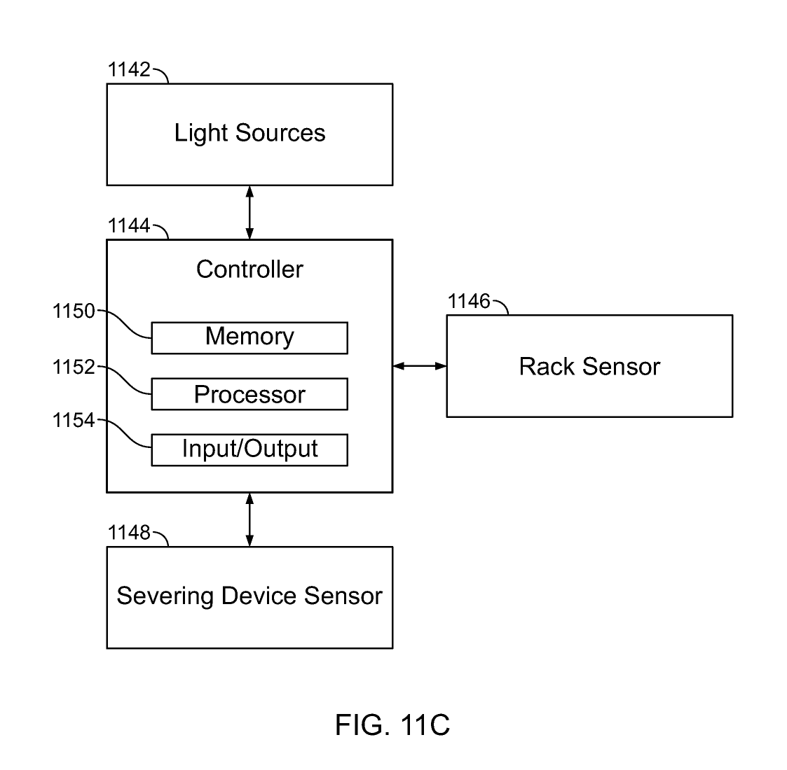

FIGS. 11A and 11B illustrate yet another example rack 1100 that may be used to perform a bottle-sabering technique. In this example, rack 1100 includes an arrangement of light sources 1142 (e.g., light-emitting diodes or LEDs) located along the body 1102 and cover member 1110. In some examples, the body and/or cover member are fashioned from a transparent or translucent material to emphasize visibility of the light sources to a user. As shown, various light sources 1142 are visible from both the front (as shown in FIG. 11B) and back (as shown in FIG. 11A) of rack 1100. However, it is noted that the illustrated arrangement of light sources is purely exemplary and is not intended to be limiting. Thus, it is envisioned that numerous arrangements of light sources are well within the scope of the present disclosure. In some examples, one or more light sources is positioned at the base of the bottle. In such examples, the rack may include reflective surfaces (e.g., mirrored surfaces) that create a light pipe effect, transporting light from the base towards the top of the rack. Thus, in some examples, the rack may appear to be illuminated entirely from top to base by a single light source.

FIG. 11C provides a schematic diagram of a control architecture for operating light sources 1142. In this example, a controller 1144 is electronically coupled to light sources 1142 and configured to (e.g., appropriately designed and programmed) operate the light sources based on feedback from a rack sensor 1146 and a severing device sensor 1148. Controller 1144 includes a memory unit 1150 that holds data and instructions for processing by processor 1152. Processor 1152 receives program instructions and sensory feedback data from memory unit 1150, executes logical operations called for by the program instructions, and generates command signals for operating light sources 1142. An input/output unit 1154 transmits the command signals to light sources 1142 and receives sensory feedback from rack sensor 1156 and severing device sensor 1148. Data corresponding to the sensory feedback is stored in the member unit 1150 for retrieval by processor 1152.

Rack sensor 1146 includes one or more sensor elements responsive to the physical state of the rack. For example, rack sensor 1146 may include a sensor (e.g., an accelerometer) element responsive to the orientation of the rack (e.g., a tilt angle), a sensor element responsive to the presence of the detachable cover member, and/or a sensor element responsive to the presence of the saber being held against the body of the rack by a user. Thus, among other things, the rack sensor can be design to provide sensory feedback data to the controller indicating when the user is preparing to execute the sabering strike and/or when the user is pouring the contents of the pressurized bottle.

Severing device sensor 1148 includes one or more sensor elements responsive to the physical state of the severing device. For example, severing device sensor 1148 may include a sensor element responsive to the position of the trigger or striker. Thus, among other things, the severing device sensor can be designed to provide sensory feedback data to the controller indicating whether the bottle top has been severed.

Controller 1144 may be configured to operate each of the light sources individually, or in predetermined groups. Further, by “operating the light sources,” we mean that the controller capable of generating command signals to change the state of the light sources, for example by: dimming or brightening the light sources, turning the light sources on or off, changing the visible color of the light sources, pulsing the light sources, etc.

In some examples, the controller is configured to alter operation of the light source in response to determining that the body has achieved an angle of tilt suitable for sabering. In some examples, the controller is configured to alter operation of the light source in response to determining that the body has achieved an angle of tilt suitable for sabering. In some examples, the controller is configured to alter operation of the light source in response to determining that the top of the bottle has been severed. Of course, the above-noted control schemes are only exemplary and not meant to be limiting. Any suitable control scheme for controlling the light sources based on sensory feedback is envisioned within the scope of the present disclosure.

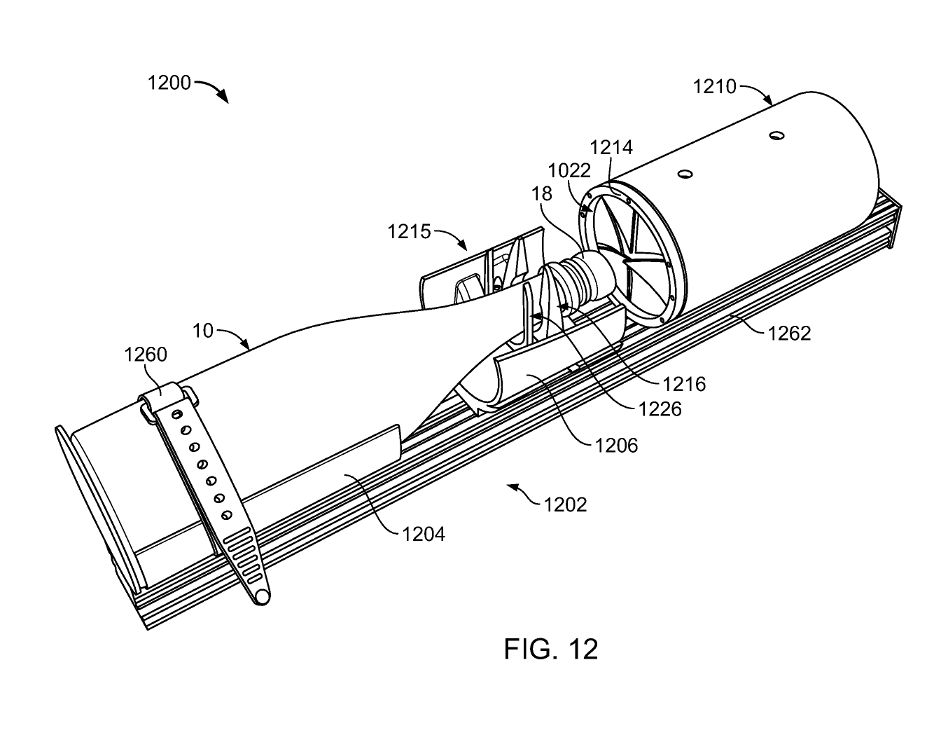

FIG. 12 shows a prototype rack 1200 that incorporates features from several embodiments described above. Thus, rack 1200 features a body 1202 including a yoke 1204 and a collar 1206 that cooperate to partially enclose bottle 10. A fastening strap 1260 secures the bottle in place against body 1202. Rack 1200 further includes a cover member 1210 defining a receptacle 1214 located above the top 18 of bottle 12. The opening of receptacle 1214 is covered by a door 1222 including a circumferential arrangement of flexible and resilient flaps. As shown, yoke 1204, collar 1206, and cover member 1210 are supported and aligned along a rigid spine 1262. Rack 1200 still further includes a severing device 1215 having a pivoting striker 1216 and a trigger 1226. The striker and trigger are U-shaped components including parallel prongs extending from a support bar rotatably coupled to the collar of the rack's body.

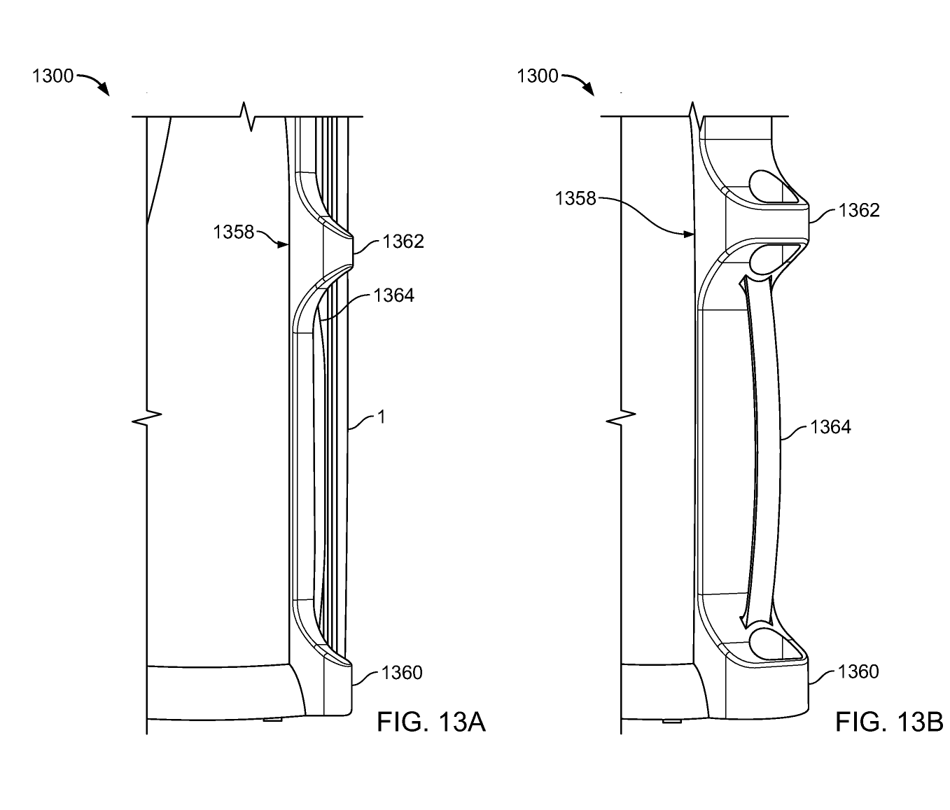

FIGS. 13A and 13B show yet another example rack 1300 that may be used to perform a bottle-sabering technique. As shown in FIG. 13A, rack 1300 includes a holster device 1358 for holding a saber 1. In this example, the holster device is positioned at the rear of the rack's body, away from the exposed portion of the enclosed bottle. In particular, the holster device is located along the spine of the rack's body. Holster device 1358 includes a receptacle 1360 at the base of rack 1300 for receiving the distal tip of saber 1 and retention member 1362 positioned directly above receptacle for receiving the saber's shank. A sprung handle 1364 is incorporated in the space between receptacle 1360 and retention member 1362. Saber 1 is held in place in holster device 1358 via a tension force caused by the convex-shaped sprung handle bearing against the shank portion of the saber between receptacle 1360 and retention member 1362. As shown in FIG. 13B, when saber 1 is removed from holster device 1358, sprung handle 1364 is deployed outwardly away from the rack's body. In this deployed position, a user can grip the handle to facilitate handling of the rack, e.g., pouring of the bottle's contents.

The use of terminology such as “front,” “back,” “top,” “bottom,” “over,” “above,” and “below” throughout the specification and claims is for describing the relative positions of various components of the system and other elements described herein. Similarly, the use of any horizontal or vertical terms to describe elements is for describing relative orientations of the various components of the system and other elements described herein. Unless otherwise stated explicitly, the use of such terminology does not imply a particular position or orientation of the system or any other components relative to the direction of the Earth gravitational force, or the Earth ground surface, or other particular position or orientation that the system other elements may be placed in during operation, manufacturing, and transportation.

A number of embodiments of the invention have been described. Nevertheless, it will be understood that various modifications may be made without departing from the spirit and scope of the inventions. For instance, various measures to facilitate a safe and repeatable sabrage technique can be implemented on the bottle itself, in addition to providing the sabering rack. For example, the bottle could be wrapped in a flexible plastic sleeve to prevent shattering.

What is claimed is:

1. A rack for bottle sabering comprising:
an elongated body defining an open compartment dimensioned to accommodate a pressurized bottle of fluid; and
a cover member coupled to the body and positioned so as to extend beyond a top of the bottle when the bottle is supported by the body,
wherein the body and the cover member cooperate to partially enclose the bottle, leaving at least an underside of a neck and rim on one side of the bottle exposed for a sabering strike to sever the top of the bottle, and
wherein the cover member defines a receptacle for catching the severed top of the bottle.

2. The rack of claim 1, wherein the bottle is positioned within the body such that a seam of the bottle is exposed for contact by a saber.

3. The rack of claim 1, wherein the open compartment is bounded by an edge surface bordering the neck and rim of the bottle, the edge surface providing a guide surface for facilitating the sabering strike.

4. The rack of claim 1, wherein the receptacle comprises an energy absorbing material.

5. The rack of claim 1, wherein the receptacle comprises a one-way door to inhibit unintentional release of the severed top of the bottle.

6. The rack of claim 1, wherein the receptacle comprises a bag mounted to receive the severed top of the bottle as the severed bottle top enters the receptacle, the bag being removable from the receptacle.

7. The rack of claim 1, further comprising a severing device coupled to the body, the severing device comprising a striker configured to strike the rim of the bottle in response to an impact on the severing device by the saber.

8. The rack of claim 7, wherein the striker is biased by a spring member that releases stored energy into the striker in response to the impact on the severing device by the saber.

9. The rack of claim 7, wherein the pressurized bottle of sprits is positioned within the body such that a seam of the bottle is aligned with the striker.

10. The rack of claim 7, wherein the severing device further comprises a trigger positioned to receive the impact by the saber and actuate the striker in response to the impact.

11. The rack of claim 1, further comprising:
at least one light source coupled to the body, and
a controller electronically coupled to the light source, and configured to operate the light source in response to feedback from at least one of:
a tilt sensor responsive to changes in the orientation of the body; and
a sensor responsive to changes in a severing device coupled to the body.

12. The rack of claim 1, further comprising a holster device coupled to the body for holstering a saber, the holster device including a sprung handle configured to move from a retracted position to a deployed position when the saber is removed from the holster device.

13. A method of opening a pressurized bottle of fluid, the method comprising:
supporting the bottle in a rack that partially encloses the bottle, leaving at least an underside of a neck and rim on one side of the bottle exposed;
sliding a saber up the neck of the bottle with force to cause an impact at the underside of the rim sufficient to sever a top of the bottle; and
catching the severed top of the bottle in a receptacle of the rack, the receptacle defined by a portion of the rack that extends beyond the top of the bottle when the bottle is supported in the rack.

14. The method of claim 13, wherein supporting the bottle in the rack comprises:
wrapping the bottle in a flexible sleeve; and
inserting the sleeved bottle into a compartment defined by the rack.

15. The method of claim 13, wherein supporting the bottle in the rack comprises positioning the bottle within a compartment defined by the rack such that a seam of the bottle is exposed.

16. The method of claim 13, wherein sliding a saber up the neck of the bottle comprises pressing the saber against a guide surface of the rack as the saber moves along the neck of the bottle.

17. The method of claim 13, wherein sliding a saber up the neck of the bottle with force to cause an impact at the underside of the rim comprises contacting an edge of the saber with the underside of the rim.

18. The method of claim 13, wherein sliding a saber up the neck of the bottle with force to cause an impact at the underside of the rim comprises contacting an edge of the saber with a severing device attached to the rack.

19. The method of claim 18, wherein the severing device comprises a striker configured to strike the rim of the bottle in response to contact by the edge of the saber.

20. A rack for bottle sabering comprising:
an elongated bottle support including a yoke and a collar,
wherein the yoke and the collar are arranged to cooperate to partially enclose a pressurized bottle of fluid supported by the bottle support, leaving at least an underside of a neck and rim on one side of the bottle exposed for a sabering strike to sever the top of the bottle, and
wherein the collar is bounded by an edge surface positioned to extend along the neck of the bottle with the bottle enclosed by the yoke and collar, the edge surface aligned with the bottle neck to provide a continuous point of contact for a saber slid along the bottle neck toward the bottle rim.
